(19) United States
(12) Patent Application Publication
(10) Pub. No.: US 2014/0156229 A1
(43) Pub. Date: Jun. 5, 2014

(54) FATIGUE-BASED TOPOLOGY OPTIMIZATION METHOD AND TOOL

(71) Applicant: CATERPILLAR INC., Peoria, IL (US)

(72) Inventors: Julian Norato, Urbana, IL (US); Chau Le, Hanoi (VN); Christopher Ha, Champaign, IL (US)

(73) Assignee: CATERPILLAR INC., Peoria, IL (US)

(21) Appl. No.: 13/692,268

(22) Filed: Dec. 3, 2012

(51) Int. Cl. G06F 17/50

(52) U.S. Cl. CPC G06F 17/50
USPC 703/1

(57) ABSTRACT

A method for performing fatigue-based topology optimization of a structure on a computational device is provided. The method may include receiving first data pertaining to a problem definition of the structure; generating a density filter; generating interpolation schemes for stiffness, volume and fatigue; generating a global fatigue measure; generating an adaptive normalization scheme; generating a regional fatigue measure; generating second data based on the first data, the density filter, the interpolation schemes, the global fatigue measure, the adaptive normalization scheme and the regional fatigue measure, the second data pertaining to an optimized solution to the problem definition; and displaying the optimized solution at an output device.

### TECHNICAL FIELD

This disclosure relates generally to systems and methods for performing fatigue-based topology optimization.

### BACKGROUND

Topology optimization is known in the art of structural design and is commonly used for optimizing the structural characteristics of a given material. More specifically, topology optimization employs a mathematical approach which aids design engineers in optimizing the distribution of a material for a given set of loads and boundary conditions so as to meet structural target performance requirements. There are several different techniques for conducting topology optimization. Among those, the material distribution technique has been well established and proven adequate in industries worldwide. However, the developments in the material distribution technique relie more upon compliance and other global response constraints, such as frequency, when in fact fatigue is one of the more important considerations.

A challenge of fatigue-based topology optimization pertains to the local nature of fatigue constraints. In an ideal continuum setting, fatigue constraints should be considered at every material point. Although in a finite element analysis, the number of such material points is still too large for practical applications. One solution to accommodate for this setback is to replace the local fatigue constraints with a single integrated fatigue constraint that approximates the maximum fatigue value. While such global approaches are computationally efficient, they do not adequately control the local fatigue behaviors.

Another challenge associated with fatigue-based topology optimization pertains to the highly nonlinear dependence of fatigue constraints on the structure or design in question. It is well known that fatigue levels are significantly affected by material distribution changes in neighboring regions. The highly nonlinear nature of fatigue constraints only increases the phenomenon in critical regions with large spatial fatigue gradients, such as reentrant corners, and the like. Accordingly, formulating design optimization problems and the algorithms for resolving the problems must be numerically consistent to avoid convergence problems.

### SUMMARY OF THE DISCLOSURE

In one aspect of the present disclosure, a method for performing fatigue-based topology optimization of a structure on a computational device is provided. The method may include the blocks of receiving first data at an input device coupled to an input of the computational device, the first data pertaining to a problem definition of the structure; generating a density filter; generating interpolation schemes for stiffness, volume and fatigue; generating a regional fatigue measure; generating a global fatigue measure; generating an adaptive normalization scheme; generating second data based on the first data, the density filter, the interpolation schemes, the global fatigue measure, the adaptive normalization scheme and the regional fatigue measure, the second data pertaining to an optimized solution to the problem definition; and displaying the optimized solution at an output device coupled to an output of the computational device.

In another aspect of the present disclosure, a system for performing fatigue-based topology optimization of a structure is provided. The system may include an input device, an output device and a computational device. The computational device may include a microprocessor and a memory for storing an algorithm for performing fatigue-based topology optimization. The algorithm may configure the computational device to receive first data at the input device, the first data pertaining to a problem definition of the structure, generate a density filter, generate interpolation schemes for stiffness, volume and fatigue, generate a global fatigue measure, generate an adaptive normalization scheme, generate a regional fatigue measure, generate second data based on the first data, the density filter, the interpolation schemes, the global fatigue measure, the adaptive normalization scheme and the regional fatigue measure, the second data pertaining to an optimized solution to the problem definition, and output the second data to the output device.

In yet another aspect of the present disclosure, a computer program product is provided. The computer program may include a computer-readable medium with control logic stored therein for configuring a computer to perform fatigue-based topology optimization. The control logic may include a series of readable program code. The program code may configure the computer to generate a density filter; generate interpolation schemes for stiffness, volume and fatigue; generate a global fatigue measure; generate an adaptive normalization scheme; and generate a regional fatigue measure.

### BRIEF DESCRIPTION OF THE DRAWINGS

FIG. 1 is a flow chart of an exemplary fatigue based topology optimization method constructed in accordance with the teachings of the present disclosure;

FIG. 2 is an illustration of a sample design item before and after the method;

FIG. 3 is an illustration of loads on an item;

FIG. 4 is an illustration of a sample design item based on stiffness and based on fatigue;

FIG. 5 is an illustration of blocks of another embodiment of the method; and

FIG. 6 is an illustration of computing blocks that may be physically configured to execute the blocks of the method.

### DETAILED DESCRIPTION

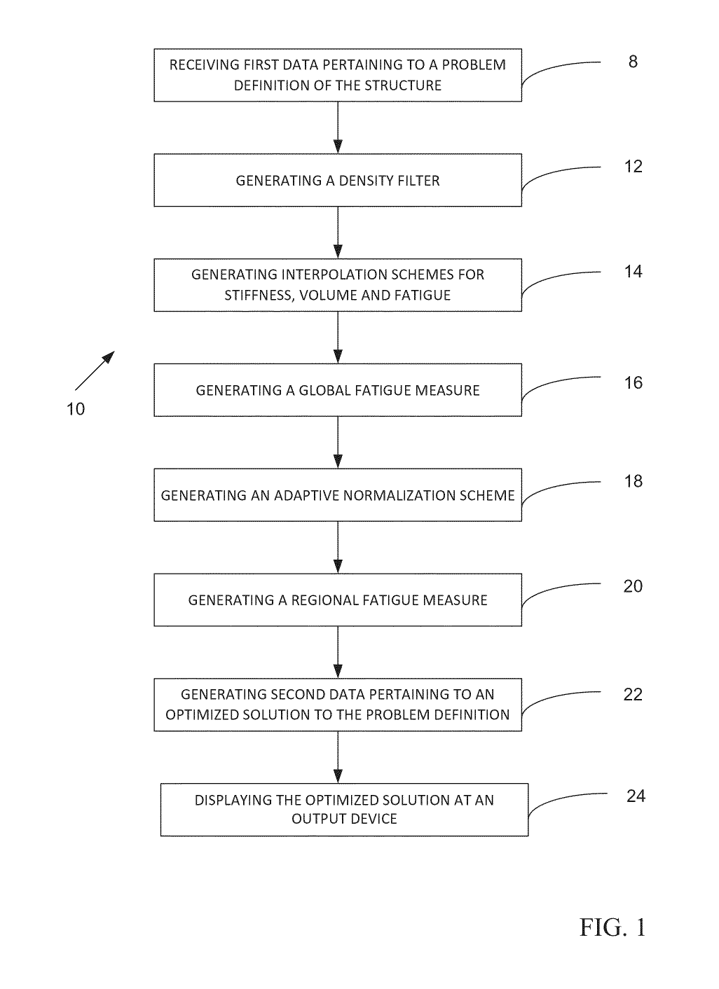

Referring to the drawings and with particular reference to FIG. 1, an exemplary method for performing fatigue based topology optimization is provided and referred to as reference number 10. It is understood that the teachings of the disclosure may be used to construct fatigue-based topology optimization techniques above and beyond those specifically disclosed below. One of ordinary skill in the art will readily understand that the following are only exemplary embodiments.

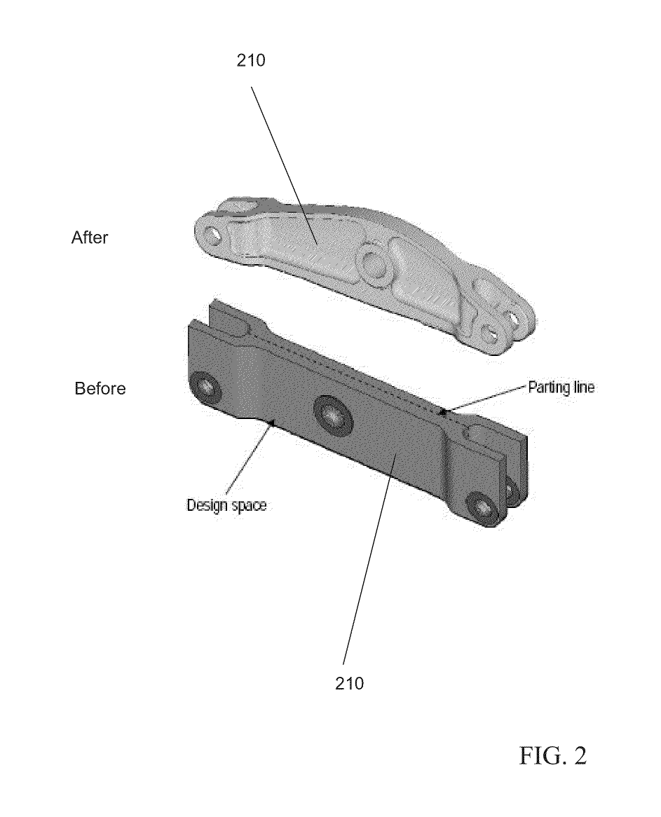

Turning to FIG. 1, an exemplary method 10 for performing fatigue-based topology optimization is provided. The method 10 may include a block 8 of receiving first data pertaining to a problem definition of the structure. At block 12, a density filter for length scale control may be generated. At block 14, interpolation schemes for stiffness, volume and fatigue may be generated. At block 16, a global fatigue measure may be generated. At block 18, an adaptive normalization scheme may be generated to precisely control the local fatigue level and at block 20, a regional fatigue measure may be generated. The result of the method 10 may be seen in FIG. 2 where an item 210 is illustrated after the method.

The density filtering technique of block 12 may be used to generate a well-posed topology optimization problem to be resolved. According to one technique, the design field d may be filtered to define the material density field ρ. Using piecewise uniform finite element discretization of density, the vectors d and ρ may include the element design variables and densities, respectively. The latter may be defined by filtering the former. For example, the filter may be defined by

$${ρ}_{i} = \frac{{\sum }_{j ∈ Ω i} {w}_{j} {d}_{j}}{{\sum }_{j ∈ Ω i} {w}_{j}} with {w}_{j} = \frac{{r}_{o} - {r}_{j}}{{r}_{o}} \qquad 〈 1 〉$$

where the domain of element Ωᵢ contains all elements j that lie within the radius rₒ of element i as measured from their respective centroids. The weighting factor wⱼ>0, as defined in expressions (1) above, may correspond to that of a cone filter where rⱼ may be the distance between the element i and j centroids. Alternative smoothing filters may also be used.

As generally applied to topology optimization problems, the density ρ may be bounded between 0 and 1. Similar bounds may be imposed on d, and thus, by defining ρ via the filter, an upper bound value for |∇ρ| may be determined where ∇ρ may be the spatial gradient of ρ. By defining ρ through the bounded d, smoothness may be imposed on ρ without requiring any additional constraints on d. Such smoothness may serve to prevent designs with small scale features, such as narrow members, jagged edges, micro-perforations, sharp interfaces, or the like.

Density-based topology optimization may be used to generate black and white designs from which structural members may be readily identified. However, the generation of black and white designs that exhibit small scale features, for example, jagged edges, at early intermediate iterations may not be so useful for the purposes of fatigue-based topology optimization. Fatigue may be a local measure which exhibits high spatial gradients. The spatial gradients may be determined from the displacement gradient. However, the displacement gradient may be determined with less accuracy than the finite element displacement field, especially in fatigue concentration regions. The resulting fatigue computed at element centroids may be artificially low with respect to the small scale features, for example, jagged edges, which are known to include fatigue singularities. Small scale features, such as jagged edges, may ultimately be smoothed in the design interpretation stages when the computed fatigue levels increase. Accordingly, it may be more effective to generate designs with smooth blurred boundaries using a filter, for example, the filter defined by expressions (1) above, than to generate designs having sharp jagged boundaries.

Still referring to FIG. 1, the method 10 for performing fatigue-based topology optimization may further include a block 14 for generating interpolation schemes for stiffness, volume and fatigue. In one such application, the method 10 may generate a solid isotropic material with penalization (SIMP) model to provide black and white designs, while further generating a fatigue relaxation definition to resolve the fatigue singularity phenomenon. Filter-induced blurred regions around structural members may facilitate the evolution of a design towards the global optima by allowing void elements to evolve to solid elements and vice-versa.

The SIMP model may be what penalizes intermediate densities and generate black and white designs which may force the optimization to prematurely converge to local optimal. Accordingly, the filter may provide smoothing for the optimization algorithm, and further, enhance its ability to converge to the global optima. In such a way, the SIMP model may be one of many interpolation schemes provided in block 14 to effectively complement the density filter provided in block 12.

In certain applications, the fatigue-based topology optimization method 10 may further generate a stress relaxation definition, for example, a SIMP-like relaxed stress definition, for solving singularities. A singularity problem may exist when optimal topologies belong to degenerate sub-spaces of a feasible design space where one or more bars have zero cross section. Convergence to such optimal topologies, or singular topologies, is essentially impossible with gradient-based optimizers. One way to eliminate such degenerate subspaces may be to relax the fatigue constraints by using, for example, the \epsilon ε-relaxation and smooth envelope functions (SEFs) and related variations that are adapted for use with continuum design. Introducing such relaxation may make the topology optimization problem more tractable by generating a smooth feasible design space.

To relax fatigue constraints, a SIMP-like relaxed stress definition may be employed. More specifically, the discrete topology optimization problem, for example, where ρε{0, 1}, may be relaxed to a continuous optimization problem, for example, where ρε[0, 1], which may be forced to generate a discrete design at the end of the optimization process. Consequently, interpolation schemes for the stiffness, volume, stress, and the like, may be defined so as to interpolate between respective possible minimum and maximum values. For stiffness, value η_{c} may be introduced to weight the solid material elasticity tensor [symbol] ₒ, as defined for example by

[symbol]

(ρ)=η_{c}(ρ) [symbol] ₒ (2)

where η_{c}, is a monotonically increasing function within the range of 0<η_{c}(ρ)≦ρ for 0<ρ<1, satisfies η_{c}(1)=1 and also satisfies η_{c}(0)=0. For volume, value may be introduced to weight the infinitesimal volume duo as

dυ=η_{υ}(ρ)dυₒ (3)

where the total volume may be determined by V=∫_{Ω}ηᵥ(ρ)dυₒ, and where ηᵥ is a monotonically increasing function within the range of 0≦ηᵥ(ρ)<1 for 0<ρ<1, satisfies ηᵥ(1)=1 and also satisfies ηᵥ(0)=0. The interpolation of stiffness and volume may essentially be responsible for the penalization of intermediate densities so as to force the final design to be discrete. For example, the interpolations corresponding to the SIMP techniques may be ηₒ(ρ)=ρ and ηᵥ(ρ)=ρ whereby the stiffness may be penalized for intermediate densities. Alternatively, the volume, or both the stiffness and the volume, may be penalized according to the sin h technique, or other comparable techniques well known in the art.

Similarly, value η_{T} may be introduced to weight the stress in the solid material, for example, Tₒ= [symbol] ₒ[∇u], as defined by

Tₒ(ρ)=ηT(ρ)Tₒ (4)

where η_{T} is a monotonically increasing function within the range of ηₒ(ρ)<n_{T}(ρ)<1 for 0<ρ<1, satisfies η_{T}(0)=0 so that the fatigue in void regions is zero and the feasible design space is smooth without degenerate regions, and further, where n_{T} in satisfies η_{T}(1)=1 so that the relaxed stress is consistent with stress in the solid material. In alternative embodiments, η_{T} may be selected to satisfy ρ<η_{T}(ρ) such that intermediate densities are further penalized by the stress interpolation.

The bounds on η_{T}, wherein η_{c}(ρ)<η_{T}(ρ)<1 for 0<ρ<1, may suggest that the interpolated stress is chosen between two limiting stress bounds, including solid fatigue defined by, for example, Tₒ= [symbol] ₒ[∇u], and macroscopic stress defined by, for example, T(ρ)= [symbol] (ρ)[∇u]=η_{c}(ρ)Tₒ. Both solid and macroscopic stress values may not be suitable for use in fatigue-based topology optimization. With respect to solid stress, stress and fatigue, at zero densities may be non-zero since the strain ∇u may typically be non-zero. As a result, the optimizer may be unable to eliminate materials in some areas of the design domain. In contrast, with respect to macroscopic fatigue, the optimizer may generate a trivial all-void design. This may be demonstrated by considering a feasible design p which may have an elasticity tensor that is defined by, for example, [symbol] (ρ)=η_{c}(ρ) [symbol] ₒ where value η_{c}(ρ) may be a homogeneous function of degree p>1, for example, where η_{c}(ρ)=ρ^{P}, and a displacement of u (ρ). Subsequently, the feasible design ρ may be uniformly scaled such that ρ→αρ where 0<α<1. For the scaled design, it may be determined that [symbol] (αρ)=(αρ) [symbol] ₒ=α^{P} η_{c}(ρ) [symbol] ₒ=α^{P} [symbol] (ρ), and further, that u (αρ)=α^{-P} u (ρ). Accordingly, further examination of the macroscopic stress may provide T(αρ)=T(ρ). Uniformly eliminating macroscopic materials may not affect the stress, and thus, the optimization may attempt to eliminate all materials.

The following section details the efficient calculation of signed von Mises fatigue life, and the subsequent section details the damage calculation, along with its sensitivities.

Signed Von Mises Fatigue Life

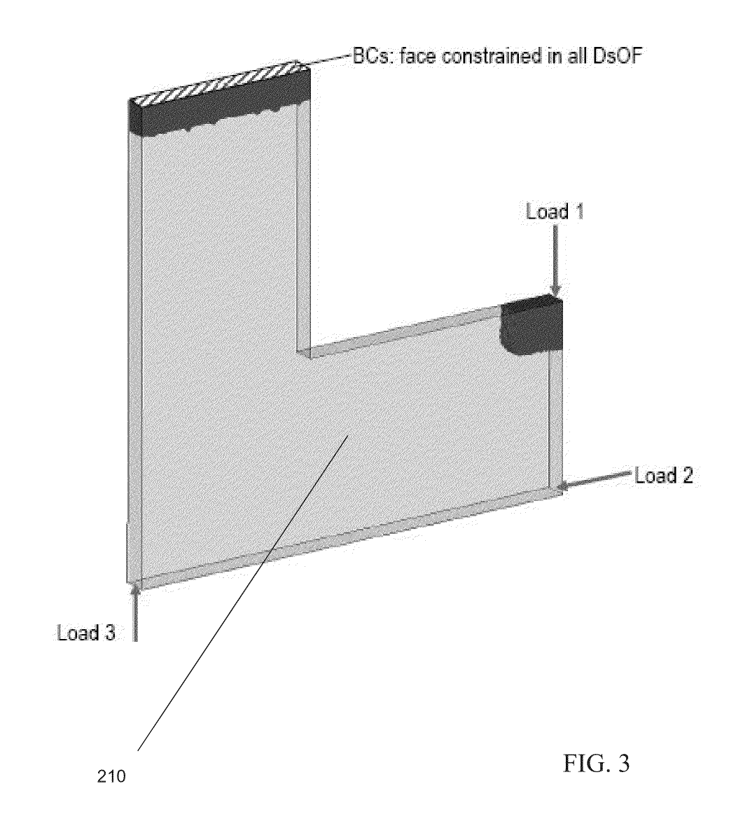

Assume that each load in the fatigue loading history is given as a linear combination of n ‘basis’ loads. FIG. 3 may illustrate some sample loads on an item 210 to be made. Consequently, the stress at any point in the structure for a time point k is given by

$${σ}_{k} = {ρ}^{r} {\sum }_{p}^{n} {α}_{p}^{k} {σ}_{p} \qquad ( a )$$

where σₚ denotes the stress state for basis loadp. Also, ρ denotes the density in the solid isotropic material model (SIMP), and r is the relaxation power. The signed von Mises stress may be given by

σ̅ₖ:=sgn(σ_{H}(σₖ))\sqrt{σₖ:Vσₖ} (b)

In the above, σ_{H} denotes the hydrostatic stress, and V is the Voigt matrix given by

$$V = [ \begin{matrix}1 & - \frac{1}{2} & - \frac{1}{2} & 0 & 0 & 0 \\ - \frac{1}{2} & 1 & - \frac{1}{2} & 0 & 0 & 0 \\ - \frac{1}{2} & - \frac{1}{2} & 1 & 0 & 0 & 0 \\ 0 & 0 & 0 & 3 & 0 & 0 \\ 0 & 0 & 0 & 0 & 3 & 0 \\ 0 & 0 & 0 & 0 & 0 & 3\end{matrix} ] \qquad ( c )$$

In order to identify the loads that make up the stress ranges for complex loading histories, a rain flow counting algorithm may be applied on the signed von Mises stresses given by Eq. 2. A stress range j, as computed by the rain flow counting algorithm, formed by loads k and k−1 is correspondingly given by

Δσⱼ:=|\tilde{σ}ₖ− σ̅_{k . . . 1}| (d)

In order to compute efficiently the stresses (which is required for each finite element, for each load in the loading history, and for each design), the structure of [0039] a may be used. First, for each finite element, compute the n² quantities

zᵢⱼ=σᵢ:Vσⱼ, i,j=1,2, . . . ,n (e)

From the finite element solution, the above can also be computed from

zᵢⱼ=uᵢ^{T}Muⱼ (f)

where u is the vector of displacements at the element nodes, and M=B^{T}VB, where B is the strain-displacement matrix. Denote by sₖ the hydrostatic stress σ_{H} (σₖ) for simplicity of notation; also, to take advantage of the optimizations of the Fortran 90 compiler for vector dot products, compute the signed von Mises stress as

\tilde{σ}ₖ=sₖvec(αₚ^{k}α_{q}^{k})^{T}vec(z_{pq}) p,q=1,2, . . . ,n (g)

where

sₖ=σ_{H}(σₖ)=vec(αₚ^{k})^{T}vec(σ_{H}(σₚ)) p,q=1,2, . . . ,n (h)

Assuming each stress range is applied once on the loading block, and damage is accumulated linearly in agreement with Palmgren-Miner's rule, the fatigue life is then given by

$$L = \frac{T}{{\sum }_{j} \frac{{n}_{j}}{{N}_{jj}}} \qquad ( i )$$

where T is the duration of one block loading, and N_{fj} is the number of cycles to failure for the jth stress range, which in turn is given by

$${N}_{fj} = \frac{1}{2} {( \frac{Δσ}{2 {σ}_{f}^{′}} )}^{\frac{1}{b}} \qquad ( j )$$

with σ′_{f} and b being material constants.

However, it is worth noting that the major advantage of providing for an internal fatigue calculation is not an improvement in speed in the life calculation itself, but the fact that analytical derivatives can be computed for the life (or damage) of an element with respect to element densities; if an external fatigue analysis tool was used to compute these sensitivities, finite differences would be required to approximate the sensitivities, and therefore N+1 finite element analyses and fatigue analysis would be required, where N is the number of elements in the design space, which is clearly computationally infeasible.

Denote an aggregate function g of the damage in the structure whose form is specified later. By the chain rule, the design sensitivity of g is given by

$$\frac{Dg}{d {ρ}_{i}} = [ {\sum }_{j} \frac{\partial g}{\partial {N}_{fj}} \frac{{DN}_{fj}}{d {Δσ}_{j}} \frac{D {Δσ}_{j}}{d {ρ}_{i}} ] + \frac{\partial g}{\partial {ρ}_{i}} \qquad ( k )$$

The following subsections will focus on deriving the sensitivities for the partial design derivatives of the cycles to failure and the stress ranges; subsequently the actual form of g may be defined and its sensitivities may be obtained using the adjoint method.

Stress Range and Cycles-to-Failure Design Sensitivities

In order to compute the stress range sensitivities, two important assumptions may be required. The first assumption is related to the sign of the hydrostatic stress. The derivative of sₖ is zero almost everywhere, and undefined at a σ_{H}=0. Assume that at all a σ_{H}≠0, and therefore ∂sₖ∂ρᵢ=0 (i.e. it is constant). The second important assumption is that an infinitesimal perturbation of ρᵢ does not alter the make up of the rain flow counting, i.e. the load locations k and k−1 in the loading history that make up range j remain the same (although their magnitudes certainly will change). With these assumptions, the design sensitivities are continuous and bounded within the range of the element densities.

The design derivative of the signed von Mises stress of element k is given by

$$\begin{matrix}\frac{D {\overline{σ}}_{k}^{( l )}}{d {ρ}_{i}} = {s}_{k} {\frac{\partial }{\partial {ρ}_{i}} [ {\sum }_{p} {\sum }_{q} {α}_{p}^{k} {α}_{q}^{k} {z}_{pq} ]}^{\frac{1}{3}} {ρ}_{l}^{r} \\ = \frac{{s}_{k} {ρ}_{l}^{r}}{2 ( {σ}_{k}^{( l )} / {ρ}_{l}^{r} )} {\sum }_{p} {\sum }_{q} {α}_{p}^{k} {α}_{q}^{k} \frac{{Dz}_{pq}}{d {ρ}_{i}} + {s}_{k} r {ρ}_{i}^{r - 1} \frac{{σ}_{k}^{( l )}}{{p}_{l}^{r}} \frac{D {ρ}_{i}}{d {ρ}_{i}} \\ = \frac{{ρ}_{l}^{2 r}}{{\tilde{σ}}_{k}^{( l )}} {\sum }_{p} {\sum }_{q} {α}_{p}^{k} {α}_{q}^{k} {u}_{p}^{T} M \frac{{Du}_{q}}{d {ρ}_{i}} + \frac{r {\tilde{σ}}_{k}^{( l )}}{{ρ}_{l}} {δ}_{li}\end{matrix} \qquad ( 1 )$$

In the above δ₁ᵢ denotes the Kronecker delta (δ₁ᵢ=1 if i=1, δ₁ᵢ=0 otherwise), and by using the fact that since M is symmetric and the indices p and q belong to the same set,

$${\sum }_{p} {\sum }_{q} {α}_{p}^{k} {α}_{q}^{k} \frac{{Dz}_{pq}}{d {ρ}_{i}} = 2 {\sum }_{p} {\sum }_{q} {α}_{p}^{k} {α}_{q}^{k} {u}_{p}^{T} M \frac{{Du}_{q}}{d {ρ}_{i}} \qquad ( m )$$

Having the above expression, the stress range design sensitivity may be derived as follows:

$$\begin{matrix}\frac{D {Δσ}_{j}^{( l )}}{d {ρ}_{i}} = sgn ( {\tilde{σ}}_{k}^{( l )} - {\tilde{σ}}_{k - 1}^{( l )} ) ( \frac{D {\tilde{σ}}_{k}^{( l )}}{d {ρ}_{i}} - \frac{D {\tilde{σ}}_{k - 1}^{( l )}}{d {ρ}_{i}} ) \\ = sgn ( {\tilde{σ}}_{k}^{( l )} - {\tilde{σ}}_{k - 1}^{( l )} ) {ρ}_{l}^{2 r} \\ [ {\sum }_{p} {\sum }_{q} ( {α}_{p}^{k} {α}_{q}^{k} - {α}_{p}^{k - 1} {α}_{q}^{k - 1} ) {u}_{p}^{T} M \frac{{Du}_{q}}{d {ρ}_{i}} ] + r {δ}_{li} \frac{{Δσ}_{j}^{( l )}}{{ρ}_{l}}\end{matrix} \qquad ( n )$$

The sensitivities of the cycles-to-failure are given by

$$\frac{{DN}_{fj}^{( l )}}{d {ρ}_{i}} = \frac{1}{{C}_{0}} \frac{D {Δσ}_{j}^{( l )}}{d {ρ}_{i}} , {C}_{0} = {2}^{b + 1} {σ}_{f}^{′} b \qquad ( o )$$

Assume that the material does not have an endurance limit, and the sloped portion of the material S-N curve intersects both axes. This guarantees differentiability of the damage cycles-to-failure for the range of the element densities.

A damage function g may be defined as

$$g := {[ {\sum }_{e}^{nel} {( {( {D}_{e} )}^{- b} )}^{P} ]}^{\frac{1}{p}} \qquad ( p )$$

where b is the fatigue parameter and Dₑ is the element damage given by

$${D}_{e} := {\sum }_{j} \frac{{n}_{j}}{{N}_{fj}^{( e )}} \qquad ( q )$$

In the above, a p-norm may be employed to force the optimizer to preferentially improve high damage regions, and the logarithm function may be employed to provide better scaling for the optimization. The design sensitivity of the damage function is given by

$$\begin{matrix}\frac{Dg}{d {ρ}_{i}} = \frac{1}{P} {g}^{1 - P} {\sum }_{e}^{nel} {P ( {( {D}_{e} )}^{- b} )}^{P - 1} ( - b ) {( {D}_{e} )}^{( - b - 1 )} \frac{{DD}_{e}}{d {ρ}_{i}} \\ = {bg}^{1 - P} {\sum }_{e}^{nel} {( {( {D}_{e} )}^{- b} )}^{P - 1} {( {D}_{e} )}^{( - b - 1 )} {\sum }_{j} \frac{{n}_{j}}{{N}_{fj}^{2}} \frac{{DN}_{fj}^{( l )}}{d {ρ}_{i}} \\ = {bg}^{1 - P} {\sum }_{e}^{nel} {( {( {D}_{e} )}^{- b} )}^{P - 1} {( {D}_{e} )}^{( - b - 1 )} {\sum }_{j} \frac{{n}_{j}}{{N}_{fj}^{2}} \frac{{N}_{fj}^{1 - b}}{{C}_{0}} \frac{D {Δσ}_{j}^{( e )}}{d {ρ}_{i}} \\ = \frac{{bg}^{1 - P}}{{C}_{0}} {\sum }_{e}^{nel} {( {( {D}_{e} )}^{- b} )}^{P} \frac{1}{{D}_{e}} {\sum }_{j} {n}_{j} {N}_{fj}^{1 - b} \frac{D {Δσ}_{j}^{( e )}}{d {ρ}_{i}} \\ = \frac{{bg}^{1 - P}}{{C}_{0}} {\sum }_{e}^{nel} {( {( {D}_{e} )}^{- b} )}^{P} \frac{1}{{D}_{e}} {\sum }_{j} {n}_{j} {N}_{fj}^{- 1 - b} \\ \{ \begin{matrix}sgn ( \begin{matrix}{\tilde{σ}}_{k}^{( e )} - \\ {\tilde{σ}}_{k - 1}^{( e )}\end{matrix} ) {ρ}_{e}^{2 r} [ {\sum }_{p} {\sum }_{q} ( \begin{matrix}\frac{{α}_{p}^{k} {α}_{q}^{k}}{{\tilde{σ}}_{k}^{( e )}} - \\ \frac{{α}_{p}^{k - 1} {α}_{q}^{k - 1}}{{\tilde{σ}}_{k - 1}^{( e )}}\end{matrix} ) {u}_{p}^{T} M \frac{{Du}_{q}}{d {ρ}_{i}} ] + \\ r {δ}_{ei} \frac{{Δσ}_{j}^{( e )}}{{ρ}_{e}}\end{matrix} \}\end{matrix} \qquad ( r )$$

With the following simplification:

$$\frac{1}{{C}_{0} {D}_{e}} {\sum }_{j}^{ } {n}_{j} {N}_{fj}^{- 1 - b} r {δ}_{ei} \frac{{Δσ}_{j}^{( e )}}{{ρ }_{e}} = \frac{r {δ}_{ei}}{b {ρ}_{e}} \qquad ( s )$$

Thus, it may be determined that

$$\frac{Dg}{d {ρ}_{i}} = \frac{{bg}^{1 - P}}{{C}_{0}} {\sum }_{e}^{nel} {( {( {D}_{e} )}^{- b} )}^{P} \frac{1}{{D}_{e}} \sum {n}_{j} {N}_{fj}^{- 1 - b} \{ sgn ( {\tilde{σ}}_{k}^{( e )} - {\tilde{σ}}_{k - 1}^{( e )} ) {ρ}_{e}^{2 r} [ {\sum }_{p}^{ } {\sum }_{q}^{ } ( \frac{{α}_{p}^{k} {α}_{q}^{k}}{{\tilde{σ}}_{k}^{( e )}} - \frac{{α}_{p}^{k - 1} {α}_{q}^{k - 1}}{{\tilde{σ}}_{k - 1}^{( e )}} ) {u}_{p}^{T} M \frac{{Du}_{q}}{d {ρ}_{i}} ] \} + {brg}^{1 - P} \frac{{( {( {D}_{i} )}^{- b} )}^{P}}{b {ρ}_{i}} \qquad ( t )$$

In order to avoid calculation of the sensitivities of the displacements corresponding to the basis loads, which is computationally prohibitive, the adjoint method may be used. The augmented Lagrangian may be defined as

$$ℒ := g + {\sum }_{q}^{ } {λ}_{q}^{T} ( {Ku}_{q} - {f}_{q} ) \qquad ( u )$$

where λ_{g} is the vector of Lagrange multipliers for basis load q, and u_{q} and f_{q} are the corresponding displacement field and applied loads respectively, and K is the stiffness matrix. Since every u_{q} satisfies equilibrium for each basis load q, the term in parenthesis in the above equation equals zero. The derivative of the augmented Lagrangian is given by

$$\frac{D ℒ}{d {ρ}_{i}} = \frac{{bg}^{1 - P}}{{C}_{0}} {\sum }_{e}^{nel} {( {( {D}_{e} )}^{- b} )}^{P} \frac{1}{{D}_{e}} {\sum }_{j}^{ } {n}_{j} {N}_{fj}^{- 1 - b} \{ sgn ( {\tilde{σ}}_{k}^{( e )} - {\tilde{σ}}_{k - 1}^{( e )} ) {ρ}_{e}^{2 r} [ {\sum }_{p}^{ } {\sum }_{q}^{ } ( \frac{{α}_{p}^{k} {α}_{q}^{k}}{{\tilde{σ}}_{k}^{( e )}} - \frac{{α}_{p}^{k - 1} {α}_{q}^{k - 1}}{{\tilde{σ}}_{k - 1}^{( e )}} ) {u}_{p}^{T} M \frac{{Du}_{q}}{d {ρ}_{i}} ] \} + {brg}^{1 - P } \frac{{( {( {D}_{i} )}^{- b} )}^{P}}{b {ρ}_{i}} + {\sum }_{q}^{ } {λ}_{q}^{T} [ \frac{DK}{d {ρ}_{i}} {u}_{q} + K \frac{{Du}_{q}}{d {ρ}_{i}} ] \qquad ( v )$$

To eliminate computation of the sensitivities of u_{q}, the equation above may be regrouped to obtain the following:

$$\frac{Dg}{d {ρ}_{i}} = {brg}^{1 - P} \frac{{( {( {D}_{i} )}^{- b} )}^{P}}{b {ρ}_{i}} + {\sum }_{q}^{ } {λ}_{q}^{T} \frac{DK}{d {ρ}_{i}} {u}_{q} \qquad ( w )$$

where λ_{q} is the solution to

$$\begin{matrix}K {λ}_{q} = - \frac{{bg}^{1 - P}}{{C}_{0}} {\sum }_{e}^{nel} {( {( {D}_{e} )}^{- b} )}^{P} \frac{{ρ}_{e}^{2 r}}{{D}_{e}} M {\sum }_{p}^{ } \{ {\sum }_{j}^{ } {n}_{j} {N}_{fj}^{- 1 - b} sgn ( {\tilde{σ}}_{k}^{( e )} - {\tilde{σ}}_{k - 1}^{( e )} ) [ ( \frac{{α}_{p}^{k} {α}_{q}^{k}}{{\tilde{σ}}_{k}} - \frac{{α}_{p}^{k - 1} {α}_{q}^{k - 1}}{{\tilde{σ}}_{k - 1}} ) ] \} {u}_{p}^{T} \\ \\ where & ( x ) \\ \frac{DK}{d {ρ}_{i}} = c {ρ}_{i}^{c - 1} {K}_{o}^{i} & ( y )\end{matrix}$$

with c being the stiffness penalization power, and Kⁱₒ denoting the stiffness matrix for element i when it is fully solid.

The method 10 of FIG. 1 may further include a block 16 of generating a global fatigue measure. In finite element-based, fatigue-constrained topology optimization problems, one fatigue constraint may be typically enforced per finite element. This may suggest that the number of fatigue constraints n may be substantially large. Furthermore, as the number of design variables may be equal to the number of elements, the number of design variables n may also be large. Therefore, sensitivity computation, by either the direct or adjoint techniques, may be prohibitively costly. In particular, as the number of pseudo-analyses in the direct technique and the number of adjoint analyses in the adjoint technique may equal n, it follows that both methods may be equally costly. To reduce the computational burden, a single global fatigue measure may be used in place of the n individual local fatigue measures, thereby making the adjoint sensitivity analysis computationally more efficient and easier to manage.

The global fatigue measure of block 16 may be defined by referring back to the original problem having n constraints, one for each element e, for example,

Dₑ≦ D̅, e=1,2, . . . (6)

where Dₑ may be the relaxed fatigue measure, D̅ may represent the respective bound, and e may be the element index. The n constraints may further be restated in terms of the single maximum fatigue constraint, for example,

$${D}_{max} ( ρ ) = {max}_{e = 1 , 2 , … , N} ( {D}_{e} ( ρ ) ) \leq \overline{D} \qquad ( 7 )$$

However, the maximum function may not be differentiable, and thus, may need to be smoothed by using, for example, p-norm or the Kreisselmeier-Steinhauser (KS) function. By adopting the p-norm measure the constraint may become

$${σ}_{PN} = {( {\sum }_{e = 1}^{N} {v}_{e} {σ}_{e}^{P} )}^{1 / P} \leq {\overline{σ}}_{PN} \\ {D}_{PN} = {( {\sum }_{e = 1}^{N} {v}_{e} {D}_{e}^{P} )}^{1 / P} \leq \overline{D} \qquad ( 8 )$$

where P may be the fatigue norm parameter and υₑ may be the element e solid volume. Accordingly, a single fatigue criterion may be imposed on the structure.

Based on expression (8), it may be determined that as the fatigue norm parameter P→∞, the p-norm D_{PN} may approach the maximum fatigue Dₘₐₓ modulo the element volume, in which case there may be no added smoothness. It may also be determined that when P->1, there may be excessive smoothness but the p-norm may approach the average fatigue, modulo the volume. A good choice for P may therefore provide adequate smoothness so that the optimization algorithm performs well and provides adequate approximation of the maximum fatigue value. This is so that the optimized design may better satisfy the imposed fatigue constraints.

For fatigue minimization formulations the choice of the fatigue norm parameter P may not be critical because the p-norm may only need to capture the trend of the maximum fatigue and not the actual maximum fatigue value.

The problem may be formulated to minimize fatigue (D_{PN} as defined for example in expression (8) above, where Dₑ may be the fatigue at the element centroids, subject to the volume constraint V≦V≦Vₘₐₓ V_{mins≦V≦V}ₘₐₓ where Vₘₐₓ may be the design domain volume, and further, may be solved with any gradient-based optimization algorithm, or the like. Lower P values may result in designs with more uniform fatigue distributions in which the fatigue concentration may be reduced. In contrast, larger P values may result in designs with more uniform fatigue distributions.

The method 10 of FIG. 1 may also include a block 18 of generating an adaptive normalization scheme. The p-norm fatigue measure D_{PN} from expression (8) above may lack physical meaning as opposed to, for example, the maximum fatigue Dₘₐₓ. In fact, an explicit mathematical expression of Dₘₐₓ in terms of D_{PN} may not exist. It follows that the ability to enforce a constraint on the maximum fatigue using the p-norm fatigue D_{PN} may also be lacking. Providing a normalized global fatigue measure may provide a better approximation of the maximum fatigue. Moreover, the normalized global fatigue measure may incorporate information from the previous optimization iteration to scale, or normalize, the global p-norm measure as c D_{PN} so that it better approximates the maximum fatigue. To define the normalization parameter c, the maximum fatigue Dₘₐₓ^{I-1} and the p-norm D_{PN}^{I-1} from the previous optimization iteration I−1 may be used. The evolving normalized global p-norm constraint at each iteration I may then be defined as

σₘₐₓ=cσ_{PN}≦ σ̅ Dₘₐₓ≈cD_{PN}≦ D̅ (9)

where c may be calculated at each optimization iteration I≦1 as

$${c}^{I} = {α}^{I} \frac{{D}_{max}^{I - 1}}{{D}_{PN}^{I - 1}} + ( 1 - {α}^{I} ) {c}^{I - 1} \qquad ( 10 )$$

The above parameter α^{j}ε(0, 1] may control the variations between c^{I} and c^{I-1}. If c tends to oscillate between iterations, α^{I} may be chosen from 0<α^{I}<1. If c does not oscillate between iterations, α^{I} may be chosen as 1. Here, α^{I} may be selected as 1. As the design converges, d^{I}=d^{I-1} so that σ_{P} N^{I}=O_{PN}^{I-1} D_{PN}^{I}≦D_{PN}^{I-1} and Dₘₐₓ^{I}≈Dₘₐₓ^{I-1}. Because the value of c may be changed in a discontinuous manner, the constraint cD_{PN}≦ D̅ may be non-differentiable and the resulting optimization problem may be slightly different for each iteration. However, as the optimization converges, the changes between successive design iterations may diminish and the corresponding value of c may converge, thereby reducing the effects of non-differentiability and inconsistency.

Each of the blocks 12, 14, 16 and 18 of the optimization method 10 of FIG. 1 may rely upon either a local or a global fatigue measure to resolve fatigue-constrained problems. Imposing local fatigue constraints may provide more precise control over local fatigue levels, but it may also require a prohibitively large computational expense. In contrast, using a single global fatigue measure may relieve the large computational expense, but it may provide poor local control over the fatigue distribution. In order to compensate for the drawbacks associated with both extremes, the method 10 of FIG. 3 may additionally include a block 20 of generating regional fatigue measures. More specifically, applying several regional fatigue measures may improve the local control while maintaining manageable computational costs. Rather than using the n constraints of expression (6) or the single global constraint of expression (9), m regional constraints may be enforced using, for example,

$${σ}_{max k} = {max}_{e ∈ {Ω}_{k}} ( {σ}_{e} ) \leq \overline{σ} , k = 1 , 2 , … , m \\ {D}_{max k} \approx {max}_{e ∈ {Ω}_{k}} ( {D}_{e} ) \leq \overline{D} , k = 1 , 2 , … , m \qquad ( 11 )$$

where Ωₖ may represent the set of elements in region k of a body region Ω. In such a way, the normalized p-norm constraint of expression (9) may be imposed over each region k using, for example,

D_{max k}≈cₖD_{PN k}≦ D̅, k=1,2, . . . ,m (12)

where cₖ may be determined independently for each region using expression (10) and where D_{PN k} may be obtained from expression (8) by considering only the elements in region Ωₖ.

Each region may be defined and based on any combination of attributes, including, but not limited to, physical location, fatigue distribution, element connectivity, and the like. In some cases, the regions may also be interlaced to generate better results. Defining regions in such a way may serve to provide better control of local fatigue. The individual regions need not be connected, or the elements that make up each region need not be contiguous. To define the interlacing regions, elements may be sorted based on respective fatigue levels at the current design iteration I, according to, for example,

{e₁,e₂, . . . ,eₙ;σₑ_{₁}^{I}≦σₑ_{₂}^{I}≦ . . . ≦σₑ_{ₙ}^{I}} {e₁,e₂, . . . ,eₙ;D^{I}ₑ_{₁}≦D^{I}ₑ_{₂}≦ . . . ≦D^{I}ₑ_{ₙ}} (13)

and then define the m regions using, for example,

Ωₖ={eₖ,eₘ₊ₖ,e₂ₘ₊ₖ . . . }, k=1,2, . . . m (14)

When the values of m=1 and m=n, where n represents the number of elements, constraints may be defined according to expressions (6) and (9).

The method 10 of FIG. 1 may also be readily extended to accommodate multiple local constraint types and multiple load cases. In some applications, it may be desirable to impose different fatigue constraints corresponding to different load cases, and possibly on different regions of a given structure. For instance, one load case may correspond to a very severe load for which a fatigue constraint on the entire structure may be related to the material's yield strength. Additionally, there may be a load case related to a repetitive, damaging load for which a fatigue constraint on the regions where the structure may be welded to its support may be related to the material's endurance limit. To accommodate for such instances, it may be possible to define the m regions accordingly. However, this may produce regional biases which may adversely affect the results. Therefore, the original constraint of expression (6) may then be redefined as, for example,

$$\frac{{σ}_{e}}{{\overline{σ}}_{e}} \leq 1 , e = 1 , 2 , … , n \\ \frac{{D}_{e}}{{\overline{D}}_{e}} \leq 1 , e = 1 , 2 , … , n \qquad ( 15 )$$

As shown in expression (15) above, σₑ Dₑ may be the respective local response, for example, it may represent either the element fatigue or the strain energy density values, and Dₑ may represent its respective bound. To define the regions based on the interlacing scheme of expression (14), the elements may be sorted by the value of Dₑ/ D̅ₑ, and each regional constraint may be redefined as, for example,

$${{C}_{k} [ {\sum }_{e ∈ {Ω}_{k}}^{ } {{v}_{{o}_{e}} ( \frac{{D}_{e}}{{\overline{D}}_{e}} )}^{P} ]}^{1 / P} \leq 1 , k = 1 , 2 , … , m \qquad ( 16 )$$

based on expressions (8), (9) and (12). Here, the value of Dₑ/ D̅ₑ rather than the value of D̅ₑ may be assumed to be non-negative. This technique may also be applied to fatigue minimization problems where D̅ₑ may become scale factors and the cost function may be defined using expression (16) with m=1 region.

A typical way to address the multiple load case problem may be to consider each of the 1 load cases separately and use m regional constraints per load case. Alternatively, all load case 1-element e fatigue ratios D^{l}ₑ/ D̅^{l}ₑ may be combined into a single set and subsequently divided into regions via an interlacing approach. Notably, the minimum number of constraints in the former approach may equal the number of load cases 1, whereas the minimum number of constraints in the latter approach may simply equal 1. Accordingly, the latter approach may be used to define the cost function for a fatigue minimization problem.

Accordingly, for the fatigue-constrained problem, the volume may be minimized subject to fatigue constraints, for example,

$${min}_{0 < d \leq 1} v ( ρ ) \\ s . t . \\ {c}_{k} {D}_{{PN}_{k}} = {[ {\sum }_{( ρ , l ) ∈ {Ω}_{k}}^{ } {{v}_{e} ( \frac{{D}_{e}^{l}}{\overline{D}} )}^{P} ]}^{1 / P} \qquad ( 17 )$$

where ρ may be the element density vector, which may be a function of the element design vector d, as defined in expression (1), where V may be the structure volume, which may be a function of ρ and d, where υₑ may be the element e solid volume, where D^{l}ₑ may be the fatigue measure in element e under load case 1, which may be an implicit function of ρ and d, where Ωₖ may be the set of element-load case fatigue in region k, where D^{l}ₑ may be the fatigue limit for element e under load case 1, where cₖ may be the normalization factor for region k, as defined in expression (10), and where m may be the number of constraints, or the number of regions. Using the same notation, the fatigue minimization problem may be defined as, for example,

$${min}_{{0 < d \leq 1}_{s . t .}} {σ}_{PN} = {[ {\sum }_{( e , l ) ∈ {Ω}_{k}}^{ } {{v}_{e} ( \frac{{σ}_{e}^{l}}{{\overline{σ}}_{e}^{l}} )}^{P} ]}^{1 / P} \\ V ( p ) \leq \overline{V} \leq {V}_{max} \\ {min {D}_{PN}}_{0 < d \leq 1} = {[ {\sum }_{( ρ , l ) ∈ {Ω}_{k}}^{ } {{v}_{e} ( \frac{{D}_{e}^{l}}{\overline{D}} )}^{P} ]}^{1 / P} \\ s . t . \\ V ( ρ ) \leq \overline{V} \leq {V}_{max} \qquad ( 18 )$$

where V̅ may be the volume limit, where Vmax may be the design domain volume, and where D̅ₑ^{l} may be interpreted as a scale factor. For completeness and for comparison purposes, the compliance minimization problem may be defined as, for example,

$${min}_{{0 < d \leq 1}_{s . t .}} U = {\int }_{Ω}^{ } ∇ u \cdot C [ ∇ u ] d v \\ V \leq \overline{V} \leq {V}_{max} \qquad ( 19 )$$

where [symbol] =η_{c}(ρ) [symbol] ₒ. In expressions (17), (18) and (19) above, the elasticity equations may define additional constraints that relate the fatigue values to the design d. The sensitivities for these implicitly defined relations may be obtained via the adjoint technique, or the like.

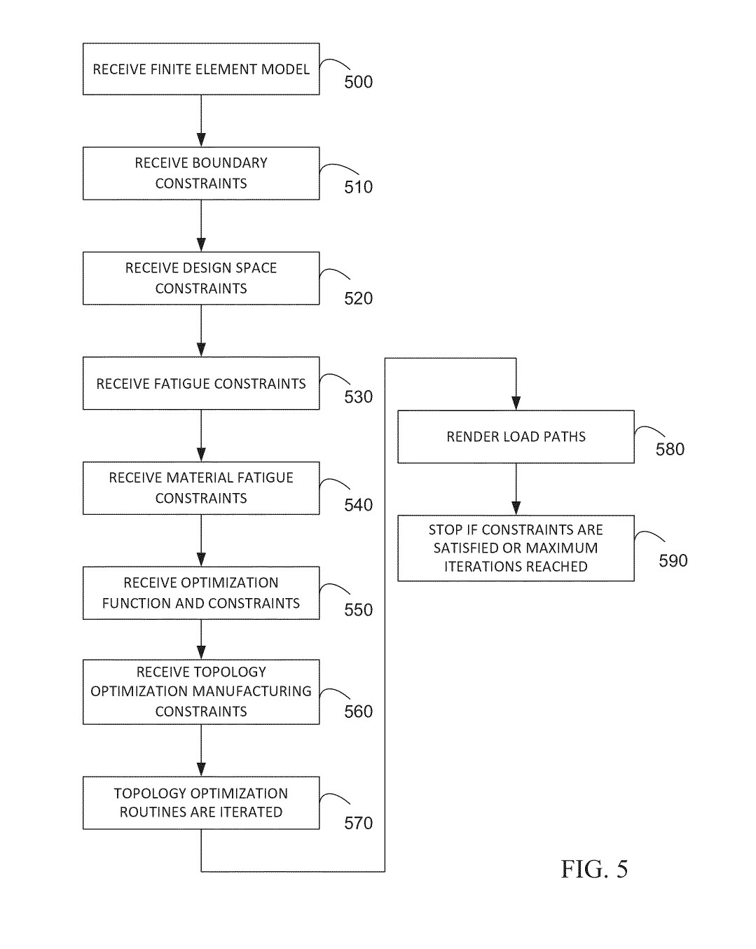

FIG. 5 may illustrate another embodiment of a method of determining load paths for a structural component of a design that minimizes mass while meeting structural requirements. At block 500, a finite element model may be received. The finite element model may include specified loadings constraints for the item 210 to be designed. The element model may be in any format that is appropriate for the item 210.

At block 510, boundary constraints may be received. The boundary constraints may be a set of boundary conditions that may be used to simulate a large system by modeling a small part that is far from its edge. At block 520, element sets may be received that define the design space constraints for the topology optimization and regions constraints upon which a durability requirement is to be imposed. The design space constraints may indicate the physical limitations for the item 210, such as it cannot be longer than 8 inches or wider than 2.4 cm in order for it to fit the space.

At block 530, fatigue loading constraints may be received. The fatigue constraints may indicate the parts of the item 210 that are under load. Multiple loads may be handled as mentioned previously.

At block 540, material fatigue property constraints may be received. As is known, different materials have different strengths. Fatigue may be a measure of at what point a crack in the material will occur over time. It is based on a history of loading which can be estimated for any given point given stress over time. The material fatigue constraints may be provided in any format that can be understood by the method.

At block 550, a definition of the optimization objective function and the constraints may be received. The objective function may vary. In some situations, weight or mass may be critical and it may be desirable to minimize the weight or mass. In other situations, the weight or mass may be of less importance while the number of repetitions before failure may be more important. Similarly, the constraints may include information like the cost of the available materials. For example, platinum may be well suited for a project but it may be incredibly expensive. At the same time, aluminum may be not as well suited but may be significantly cheaper.

At block 570, topology optimization routines may be iterated which may include determining the fatigue at every point of the structural component and employing correction to account for the effect of mean fatigue.

At block 580, load paths may be rendered that either have a smaller objective function than the previous iteration and satisfy the constraints or have a larger objective function but violates the constraints less than previous iterations. At block 790, the method may be stopped if either the constraints are satisfied and the change between consecutive iterations is negligible or if a maximum number of iterations has been reached.

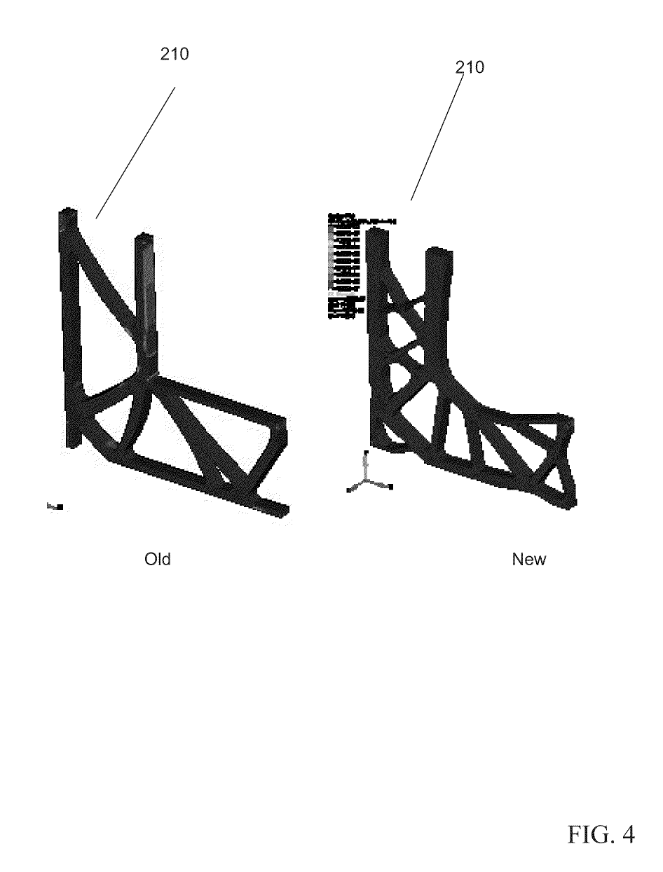

The results of the method may be seen in FIG. 4. In FIG. 4, the new design is more durable than the stiffness-based design using fatigue and load paths as a design principle.

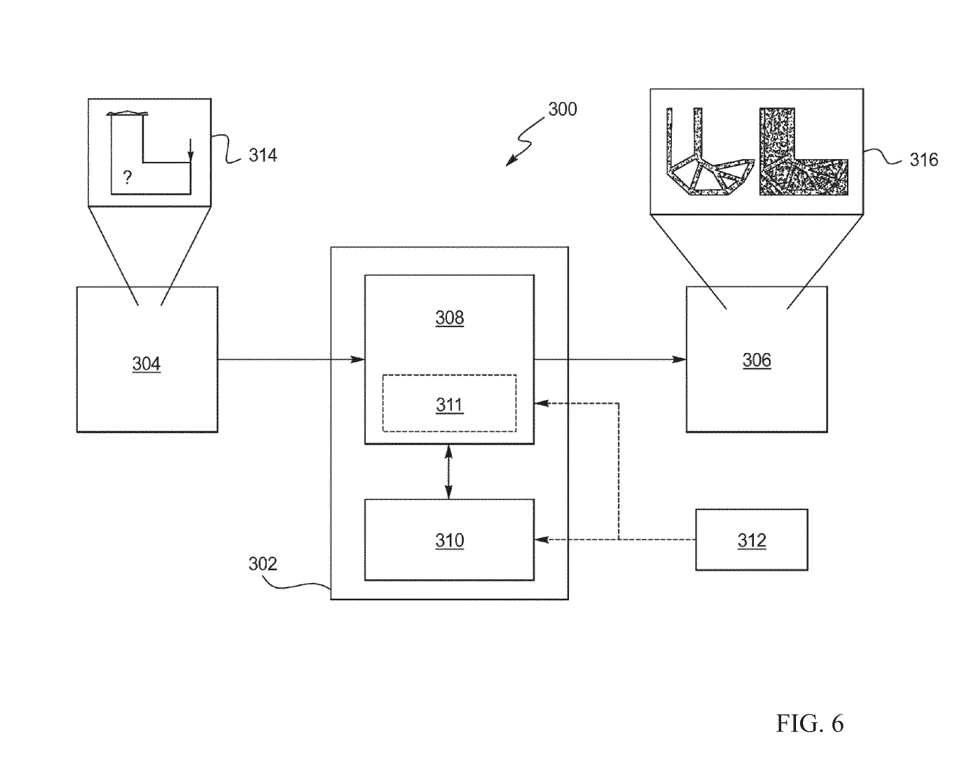

Turning now to FIG. 6, an exemplary system 300 for optimizing fatigue-based topologies of a given structure is provided. The system 300 may include a computer or computational device 302, an input device 304 and an output device 306. The computational device 302 may include a microprocessor 308 and a memory 310. The algorithm for performing fatigue-based topology optimization, for example, the method 10 of FIG. 3, may be stored or installed on the memory 310 of the computational device 302 so as to be readily accessible by the microprocessor 308. Alternatively, the microprocessor 308 may include on-board memory 311 similarly capable of storing the algorithm and allowing the microprocessor 308 access thereto. The algorithm may also be provided on a removable computer-readable medium 312 in the form of a computer program product. Specifically, the algorithm may be stored on the removable medium 312 as control logic or a set of program codes which configure the computational device 302 to perform according to the algorithm. The removable medium 312 may be provided as, for example, a compact disc (CD), a floppy, a removable hard drive, a universal serial bus (USB) drive, or any other computer-readable removable storage device. Upon inserting or electronically coupling the removable medium 312 to the microprocessor 308, the microprocessor 308 may be enabled to access the algorithm stored thereon. Furthermore, the input device 304 may include one or more of a mouse, keyboard, touchpad, touch-screen display, or the like. The output device 306 may be implemented as a monitor, printer, or the like.

During operation, the input device 304 may be configured to receive a problem definition that may be specified by a user. More specifically, a user may input into the input device 304 information or first data 314 pertaining to the problem definition to be resolved including, for example, geometries or dimensions of a given structure, material of the given structure, fatigue criteria, load data, and the like. From the input device 304, the problem definition or first data 314 may be transmitted to the computational device 302. In some embodiments, the first data 314 may also be temporarily stored within the memory 310 for retrieval by the microprocessor 308.

The computational device 302 may then proceed to convert the problem definition data 314 into a second data or solution data 316 in accordance with the algorithm. Moreover, in response to the received first data 314, the microprocessor 308 may access the algorithm from any one of the storage devices 310, 311 and 312, to begin generating an optimized solution to the problem defined by the user according to the fatigue-based topology optimization method 10 of FIG. 1. Once the solution data 316 has been determined, the microprocessor 308 may be enabled to render the optimized solution as, for example, structural design images representing density and/or fatigue distributions. The microprocessor 308 may then be enabled to transmit the solution data 316 and the associated rendered images to the output device 306 to be displayed or presented to the user.

### INDUSTRIAL APPLICABILITY

The foregoing disclosure finds utility in any structural design application that may demand more accurate characterization of a concept structure before reducing the structure to tangible builds and actual strength and/or durability testing. In the construction industry, for example, the disclosed fatigue-based topology optimization method 10 may be used to conceptualize the structural characteristics of a novel work tool of a construction vehicle so as to better predict the optimum design for the novel work tool. This can significantly reduce the time and costs associated with repeatedly building a number of work tools with slightly modified designs and subjecting the work tools to strength tests.

What is claimed is:

1. A method for performing fatigue-based topology optimization of a structure on a computational device, comprising the blocks of:
receiving first data at an input device coupled to an input of the computational device the first data pertaining to a problem definition of the structure;
generating a density filter;
generating interpolation schemes for stiffness, volume and fatigue;
generating a global fatigue measure;
generating an adaptive normalization scheme;
generating a regional fatigue measure;
generating second data based on the first data, the density filter, the interpolation schemes, the global fatigue measure, the adaptive normalization scheme and the regional fatigue measure, the second data pertaining to an optimized solution to the problem definition; and
displaying the optimized solution at an output device coupled to an output of the computational device.

2. The method of claim 1, wherein the interpolation schemes includes a solid isotropic material with penalization (SIMP) model for stiffness and volume.

3. The method of claim 1, wherein the first data includes information pertaining to geometric features of the structure, material features of the structure, and fatigue constraints imposed upon the structure;

4. The method of claim 1, wherein the first data includes finite element analysis information, material model information, filter radius information and load distribution information.

5. The method of claim 1, wherein the second data includes information pertaining to maximum fatigue and compliance values.

6. The method of claim 1, wherein the output device is a monitor configured to display the optimized solution as structural design images representing density and fatigue distributions.

7. The method of claim 1, wherein the adaptive normalization scheme relies upon previous optimization iteration information to normalize the global fatigue measure.

8. The method of claim 1, wherein the regional fatigue measure defines a plurality of regions that are interlaced based on elements that are sorted according to respective fatigue levels.

9. A system for performing fatigue-based topology optimization of a structure, comprising:
an input device;
an output device; and
a computational device having a microprocessor and a memory for storing an algorithm for performing fatigue based topology optimization, the algorithm configuring the computational device to:
receive first data at an input device coupled to an input of the computational device the first data pertaining to a problem definition of the structure;
generate a density filter;
generate interpolation schemes for stiffness, volume and fatigue;
generate a global fatigue measure;
generate an adaptive normalization scheme;
generate a regional fatigue measure;
generate second data based on the first data, the density filter, the interpolation schemes, the global fatigue measure, the adaptive normalization scheme and the regional fatigue measure, the second data pertaining to an optimized solution to the problem definition; and
display the optimized solution at an output device coupled to an output of the computational device.

10. A method of determining load paths for a structural component of a metal design that minimizes mass while meeting structural requirements comprising:
receiving a finite element model comprising specified loadings constraints receiving boundary constraints;
receiving element sets that define the design space constraints for the topology optimization and regions constraints upon which a durability requirement is to be imposed;
receiving fatigue loading constraints;
receiving material fatigue property constraints;
receiving a definition of the optimization objective function and the constraints;
iterating through topology optimization routines comprising
determining the fatigue at every point of the structural component;
employing correction to account for the effect of mean fatigue;
rendering load paths that at least one of:
have a smaller objective function than the previous iteration and satisfy the constraints or
has a larger objective function but violates the constraints less than previous iterations.
Stopping the method if
the constraints are satisfied and the change between consecutive iterations is negligible or
if a maximum number of iterations has been reached.

11. The method of claim 10, further comprising outputing a set of load paths that are rendered.

12. The method of claim 10, wherein boundary conditions relate to design of object.

13. The method of claim 10, wherein material properties are provided by user.

14. The method of claim 10, wherein determining the fatigue at every point of the structural component further comprises using signed von Mises fatigue algorithm to determine fatigue.

15. The method of claim 10, wherein the fatigue data is analyzed using a rainflow counting algorithm of the ASTM E 1049-85 standard.

16. The method of claim 10, wherein rendering occurs using commercially available finite element post-processing tools.

17. The method of claim 10, further comprising outputting the values of the objective function and constrain function for each iteration.

18. The method of claim 10, further comprising determining the changes in fatigue with respect to topology design variables.

19. The method of claim 10, wherein the interpolation schemes includes a solid isotropic material with penalization (SIMP) model for stiffness and volume.
